(19) United States
(12) Patent Application Publication
(10) Pub. No.: US 2017/0187461 A1
(43) Pub. Date: Jun. 29, 2017

(54) OPTICAL SIGNAL REPEATER, OPTICAL COMMUNICATION SYSTEM, AND METHOD OF REPEATING OPTICAL SIGNAL

(71) Applicant: Sumitomo Electric Industries, Ltd., Osaka-shi, Osaka (JP)

(72) Inventors: Yasuhiro TAKIZAWA, Osaka-shi, Osaka (JP); Shinya GOTO, Osaka-shi, Osaka (JP); Kazutaka KAWAMOTO, Osaka-shi, Osaka (JP)

(73) Assignee: Sumitomo Electric Industries, Ltd., Osaka-shi, Osaka (JP)

(21) Appl. No.: 15/316,557

(22) PCT Filed: Jan. 26, 2016
(86) PCT No.: PCT/JP2016/052130

§ 371 Date: Dec. 6, 2016

(30) Foreign Application Priority Data
May 13, 2015 (JP) 2015-097868

(51) Int. Cl. H04B 10/29; H04L 12/721; H04L 12/751; H04B 10/27

(52) U.S. Cl. CPC H04B 10/29; H04B 10/27; H04L 45/12; H04L 45/02

(57) ABSTRACT

An optical signal repeater, an optical communication system, and a method of repeating an optical signal capable of decreasing a difference in transmission time period due to a difference in transmission distance of an optical signal between an optical line terminal and a plurality of optical network units connected through branched communication paths are provided. An optical signal repeat is an optical signal repeater for repeating an optical signal transmitted between an optical line terminal and a plurality of optical network units connected through branched communication paths. The optical signal repeater includes a delay element. The delay element is provided between the ONU connected to the OLT through a shortest communication path among the branched communication paths and the OLT and delays transmission of the optical signal transmitted through the shortest communication path.

### TECHNICAL FIELD

The present invention relates to an optical signal repeater, an optical communication system, and a method of repeating an optical signal.

### BACKGROUND ART

A passive optical network (PON) system represents one type of optical communication systems. The PON system includes an optical line terminal (OLT), one or more optical network units (ONU), an optical fiber for transmission of an optical signal, and an optical splitter branching the optical fiber, The OLT is connected to the ONU through the optical fiber and the optical splitter. The optical splitter is placed between the OLT and the ONU. Thus, a plurality of ONUs can be connected to one OLT.

In a case where a transmission distance between the OLT and the ONU is long, an optical signal repeater can be arranged in an optical fiber line between the OLT and the ONU. A configuration example of the PON system including an optical signal repeater is disclosed, for example, in Japanese Patent Laying-Open No. 2008-17323 (PTD 1)

### CITATION LIST

### Patent Document

PTD 1: Japanese Patent Laying-Open No. 2008-17323

### SUMMARY OF INVENTION

### Technical Problem

When a plurality of ONUs are connected through branched communication paths, transmission distances may be different among the branched communication paths. Time periods for transmission of a signal are varied over a certain range among the branched communication paths. If the range is wide, for example, problems as follows may arise.

An OLT performs discovery processing for connecting an ONU on a PON line to the OLT. When the OLT performs a discovery function, the OLT broadcasts a control frame called a discovery gate. The ONU which has received the discovery gate transmits a register request after a random delay

The OLT sets a time window called a discovery window for detection and registration of the ONU. When the OLT receives a register request within the time window, the OLT registers the ONU which has transmitted the register request in the OLT. Thus, the ONU can be connected (linked up) to the OLT.

A width of the discovery window should be set in consideration of a transmission distance from the OUT to each ONU. When the OUT receives register requests from both of the ONU closest to the OLT and the ONU farthest from the OLT within a single discovery window, a width of the discovery window may be large. If the width of the discovery window is large, the OLT should use a wider bandwidth. By allocating a wide bandwidth to the discovery window, for example, such a problem as lowering in throughput of data in the OUT may arise.

An object of the present invention is to provide an optical signal repeater, an optical communication system, and an optical signal repeating method capable of decreasing a difference in transmission time period due to a difference in transmission distance of an optical signal between an optical line terminal and a plurality of optical network units connected through branched communication paths.

### Solution to Problem

An optical signal repeater according to one embodiment of the present invention is an optical signal repeater configured to repeat an optical signal transmitted between an optical line terminal and a plurality of optical network units connected through branched communication paths. The optical signal repeater includes a delay element. The delay element is provided between the optical network unit connected to the optical line terminal through a shortest communication path among the branched communication paths and the optical line terminal, and configured to delay transmission of an optical signal transmitted through the shortest communication path

### Advantageous Effects of Invention

According to the above, a difference in transmission time period due to a difference in transmission distance of an optical signal between an optical line terminal and a plurality of optical network units connected through branched communication paths can be decreased.

### BRIEF DESCRIPTION OF DRAWINGS

FIG. 1 is a schematic diagram showing a configuration example of an optical communication system according to a first embodiment of the present invention.

FIG. 2 is a block diagram showing one example of a configuration of each of an OLT and an optical signal repeater shown in FIG. 1.

FIG. 3 is a sequence diagram illustrating discovery processing in an OLT when delay of transmission of an optical signal is not set in an optical signal repeater.

FIG. 4 is a sequence diagram illustrating discovery processing in an OLT when delay of transmission of an optical signal is set in an optical signal repeater.

FIG. 5 is a flowchart showing processing in a delay element in the optical signal repeater according to the first embodiment.

FIG. 6 is a schematic diagram showing a configuration example of an optical communication system according to a second embodiment of the present invention.

FIG. 7 is a block diagram showing one example of a configuration of an optical signal repeater according to the second embodiment.

### DESCRIPTION OF EMBODIMENTS

[Description of Embodiments of Present Invention]

Embodiments of the present invention will initially be listed and described.

(1) An optical signal repeater according to one embodiment of the present invention is an optical signal repeater configured to repeat an optical signal transmitted between an optical line terminal and a plurality of optical network units connected through branched communication paths. The optical signal repeater includes a delay element. The delay element is provided between the optical network unit connected to the optical line terminal through a shortest communication path among the branched communication paths and the optical line terminal, and configured to delay transmission of an optical signal transmitted through the shortest communication path.

According to the above, a difference in transmission time period due to a difference, in transmission distance of an optical signal between the optical line terminal and the plurality of optical network units connected through the branched communications paths can be decreased. A communication path shortest in time period for transmission of an optical signal among the branched communication paths is the communication path shortest in transmission distance from the optical line terminal. When a difference in length between this communication path and another communication path (for example, a longest communication path) is great, a difference in time period for transmission of an optical signal is great. The delay element can increase a time period for transmission of an optical signal transmitted through the shortest communication path. Therefore, a difference in transmission time period due to the difference in transmission distance of the optical signal can be decreased.

A delay may be fixed or variable. A signal to be delayed may be any of a signal sent from an optical line terminal, a signal sent from an optical network unit, and both of them. A signal to be delayed may be a signal of a specific type, or a type thereof does not have to be limited.

(2) Preferably, the optical network unit connected through the shortest communication path among the plurality of optical network units is included in the optical signal repeater.

According to the above, hi the optical signal repeater containing the optical network unit, a difference in time period for transmission of an optical signal can be decreased.

(3) Preferably, the delay element delays transmission of the optical signal transmitted between the optical line terminal and the plurality of optical network units when the optical line terminal performs discovery processing.

According to the above, a width (bandwidth) of a discovery window set in the optical line terminal can he made smaller.

(4) An optical communication system according to one embodiment of the present invention includes an optical line terminal, branched communication paths, a plurality of optical network units connected through the branched communication paths, and an optical signal repeater configured to repeat an optical signal transmitted between the optical line terminal and each of the plurality of optical network units. The optical signal repeater is configured to delay transmission of the optical signal transmitted between the optical network unit connected to the optical line terminal through a shortest communication path among the branched communication paths and the optical line terminal.

According to the above, a difference in transmission time period due to a difference in transmission distance of an optical signal between an optical line terminal and a plurality of optical network units connected through branched communication paths can be decreased.

(5) A method of repeating an optical signal according to one embodiment of the present invention is a method of repeating an optical signal between an optical line terminal and a plurality of optical network units connected to the optical line terminal through branched communication paths. The method includes the step of delaying transmission of the optical signal transmitted between the optical network unit connected to the optical line terminal through a shortest communication path among the branched communication paths and the optical line terminal.

According to the above, a difference in transmission time period due to a difference in transmission distance of an optical signal between an optical line terminal and a plurality of optical network units connected through branched communication paths can be decreased.

[Details of Embodiments of Present Invention]

Embodiments of the present invention will be described hereinafter with reference to the drawings. The same or corresponding. elements in the drawings have the same reference numerals allotted and description thereof will not be repeated.

<First Embodiment>

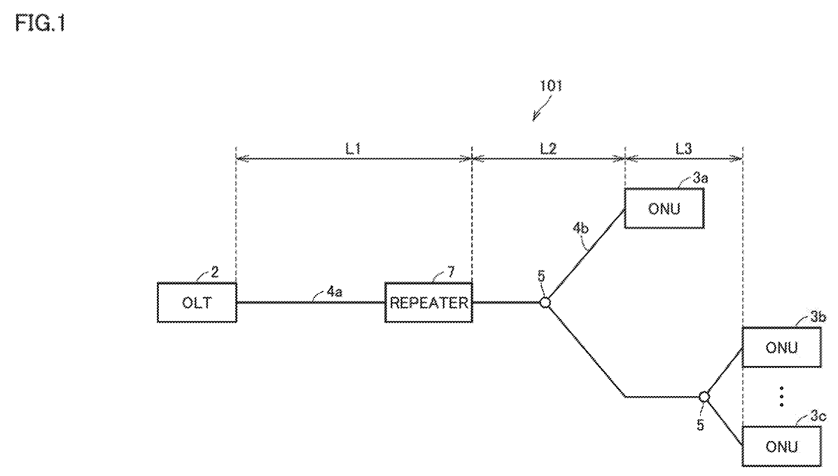

FIG. 1 is a schematic diagram showing a configuration example of an optical communication system 101 according to a first embodiment of the present invention. Referring to FIG. 1, optical communication system 101 includes an optical line terminal 2, a plurality of optical network units 3a, 3b, and 3c, a trunk optical fiber 4a, a plurality of branch optical fibers 4b, an optical splitter 5, and an optical signal repeater 7. The optical line terminal is hereinafter referred to as an “OLT” and the optical network unit is hereinafter referred to as an “ONU”. For brevity of the drawings, FIG. 1 representatively shows three ONUs 3a, 3b, and 3c. The number of ONUs included in optical communication system 101, however, is not limited.

Optical communication system 101 is implemented as a PON system. The IEEE 802.3 standards define GE-PON and 10G-EPON as the standards for PON. One of differences between GE-PON and 10G-EPON is a communication rate (a transmission rate). Optical communication system 101 may be a system including any one of GE-PON and 10G-EPON or a system including both of GE-PON and 10G-EPON. A communication rate (a transmission rate) of GE-PON is set to 1.25 gigabits per second (Gbps). A transmission rate of 10G-EPON is set to 10.3125 Gbps.

Trunk optical fiber 4a is connected to OLT 2. Each branch optical fiber 4b is connected to a corresponding ONU. Optical splitter 5 connects trunk optical fiber 4a and a plurality of branch optical fibers 4b to each other. Therefore, ONUs 3a, 3b, and 3c are connected through branched communication paths.

Optical splitter 5 is connected to trunk optical fiber 4a and a plurality of branch optical fibers 4b. Optical splitter 5 distributes optical signals sent through trunk optical fiber 4a to the plurality of branch optical fibers 4b. Optical splitter 5 multiplexes optical signals sent through the plurality of branch optical fibers 4b and sends the optical signals through trunk optical fiber 4a.

Optical signal repeater 7 is a device repeating an optical signal transmitted between OLT 2 and each of ONUs 3a, 3b, and 3c. Optical signal repeater 7 allows extension of a transmission distance of an optical signal. When optical signal repeater 7 receives an optical signal, it converts the optical signal to an electric signal. Optical signal repeat 7 subjects the electric signal, for example, to such processing as amplification and clock recovery. Then, optical signal repeater 7 converts the electric signal to an optical signal and sends the optical signal.

ONUs 3a, 3b, and 3c are arranged downstream of optical signal repeater 7 in a communication path for an optical signal L1 represents a length of a communication path from OLT 2 to optical signal repeater 7. L2 represents a length of a communication path from optical signal repeater 7 to ONU 3a. L3 represents a length of a communication path between ONU 2a and each of ONUs 3b and 3c. For brevity of description below, communication paths from optical signal repeater 7 to ONUs 3b and 3c are assumed to substantially be equal to each other in length A “length of a communication path” is also hereinafter referred to as a “distance”. According to the configuration example shown in FIG. 1, relation of L3>0 is satisfied. Namely, ONUs 3b and 3c are located father from OLT 2 than ONU 3a.

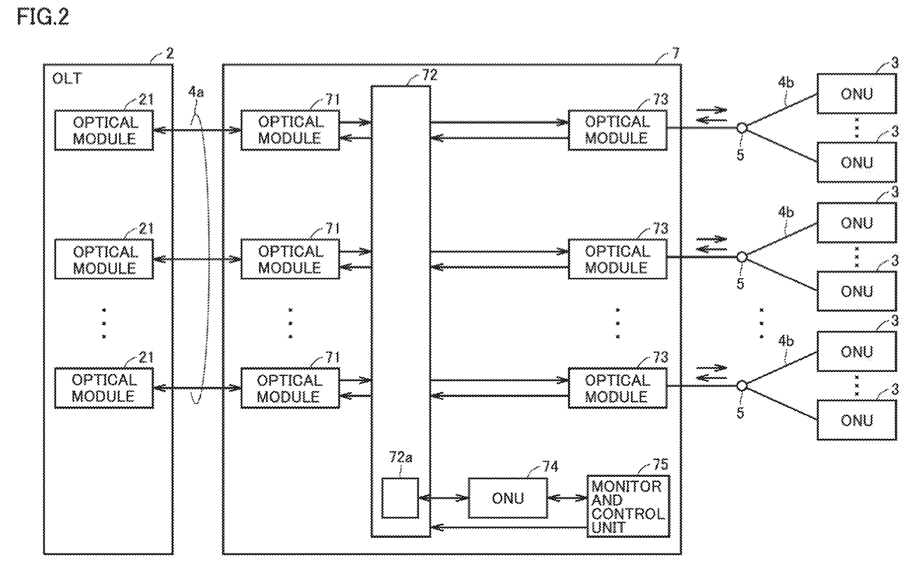

FIG. 2 is a block diagram showing one example of a configuration of each of the OLT and the optical signal repeater shown in FIG. 1. FIG. 2 shows a main portion of each of OLT 2 and optical signal repeater 7. Referring to FIG. 2, OLT 2 includes a plurality of optical modules 21. Each optical module 21 converts an electric signal to an optical signal and sends the optical signal through trunk optical fiber 4a. Optical module 21 receives an optical signal through trunk optical fiber 4a and converts the optical signal to an electric signal. An electric signal is transmitted within OLT 2.

Optical signals can be transmitted between a plurality of optical modules 21 and optical signal repeater 7, for example, based on time division multiplexing or wavelength multiplexing.

Optical signal repeater 7 includes a plurality of optical modules 71, a transmission control unit 72, a plurality of optical modules 73, an ONU 74, and a monitor and control unit 75.

Each of the plurality of optical modules 71 transmits and receives an optical signal to and from corresponding optical module 21 among the plurality of optical modules 21 of OLT 2. Each optical module 71 converts an optical signal from corresponding optical module 21 to an electric signal. Each optical module 71 converts an electric signal from corresponding optical module 73 to an optical signal and sends the optical signal through trunk optical fiber 4a.

Each of the plurality of optical modules 73 is connected to optical splitter 5 through the trunk optical fiber. A plurality of branch optical fibers 4b are branched from each optical splitter 5. ON 3 is connected to branch optical fiber 4b branched from optical splitter 5. The number of branch optical fibers 4b branched from optical splitter 5 is not particularly limited.

Each optical module 73 exchanges an optical signal with ONU 3 connected to that optical module 73. Each optical module 73 exchanges an electric signal with corresponding optical module 71. Optical module 73 converts an electric signal from optical module 71 to an optical signal and sends the optical signal through the optical fiber. Optical module 73 converts an optical signal from ONU 3 to an electric signal and transmits the electric signal to corresponding optical module 71.

Transmission control unit 72 sets a signal path between a plurality of optical modules 71 and a plurality of optical modules 73. Transmission control unit 72 can change a signal path.

ONU 74 monitors and controls optical signal repeater 7 ONU 74 allows remote monitoring, for example, on a side of a terminal (center). Monitor and control unit 75 controls ONU 74 and transmission control unit 72. ONU 74 is the same in function as ONU 3.

Transmission control unit 72 includes a delay element 72a. Delay element 72a delays transmission of a signal sent to ONU 74. Instead, delay element 72a may delay transmission of a signal sent from ONU 74. Alternatively, delay element 72a may delay transmission of both of a signal sent to ONU 74 and a signal sent from ONU 74.

For example, when delay element 72a receives a message, it holds the message for a certain period of time. After the time period elapsed, delay element 72a outputs the message. A delay corresponds to a period of time for holding the message.

Delay element 72a may be implemented by a dedicated circuit or as a part of transmission control unit 72 by software which operates transmission control unit 72. Transmission control unit 72 can be implemented, for example, by a field programmable gate array (FPGA).

For example, delay element 72a may identify a type of a message sent in a form of an electric signal. Delay element 72a may delay transmission of a signal (a message) of a specific type among signals transmitted between ONU 74 and OLT 2. Alternatively, delay element 72a may delay transmission of a signal between ONU 74 and OLT 2 regardless of a type of a signal.

According to one embodiment, a transmission delay in delay element 72a is set in advance. The set delay is longer than 0 and not longer than a time period required for an optical signal to be transmitted over a distance (L2+L3). Preferably, the delay is not shorter than a time period required for an optical signal to be transmitted over distance L2 and not longer than a time period required for an optical signal to be transmitted over the distance (L2 +L3). More preferably, the delay is equal to a time period required for an optical signal to be transmitted over distance L2.

The delay may dynamically be set. For example, the delay can be set based on a time period for transmission of an optical signal between OLT 2 and ONU 74 and a time period for transmission of an optical signal between OLT 2 and each ONU 3, The delay may be set so as to be within the range above.

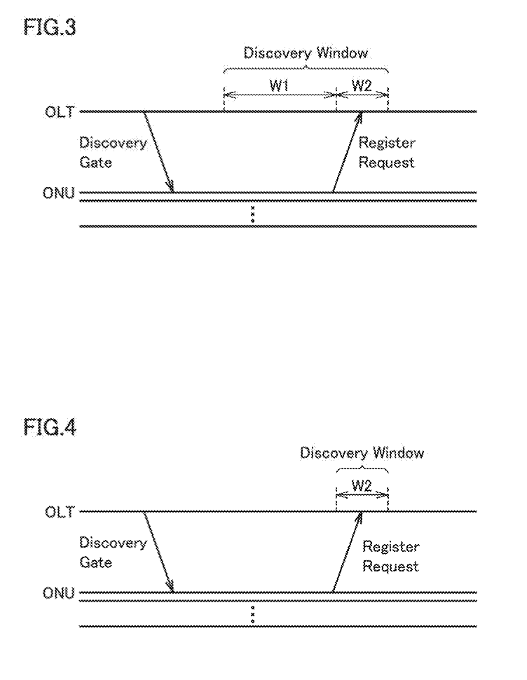

FIG. 3 is a sequence diagram illustrating discovery processing in an OLT when delay of transmission of an optical signal is not set in an optical signal repeater. Referring to FIG. 3, OLT 2 broadcasts a discovery gate to an ONE The ONU which has received the discovery gate transmits a register request after a random delay.

The OLT sets a time window called a discovery window for detection and registration of an ONU. When OLT 2. receives the register request within the discovery window, it registers the ONU which has transmitted the register request in the OLT.

As shown in FIG. 1, distances from OLT 2 to ONUs may be different from one another. Therefore, a transmission distance of an optical signal between OLT 2 and an ONU closest to OLT 2 and a distance of an optical signal between OLT 2 and an ONU farthest from OLT 2 should be taken into account in connection with a width of the discovery window.

As shown in FIG. 2, the ONU closest to OLT 2 is ONU 74 within optical signal repeater 7 The ONU farthest from OLT 2 is ONU 3b ONU 3c. A distance from OLT 2 to ONU 3b or ONU 3c is (L1+L2+L3).

A width (bandwidth) of the discovery window has a width (bandwidth) corresponding to a difference (=L2+L3) between distance L1 and the distance (L1+L2+L3). Specifically, the discovery window can be expressed with a sum of a window W1 and a window W2. Window W1 is a bandwidth corresponding to distance L2. Window W2 is a bandwidth corresponding to distance L3.

While the discovery window is open, OLT 2 may be unable to receive uplink data which has reached OLT 2. Therefore, as the discovery window has a larger width (bandwidth), the probability of failure in reception by OLT 2 of uplink. data transmitted from the registered ONU may be high.

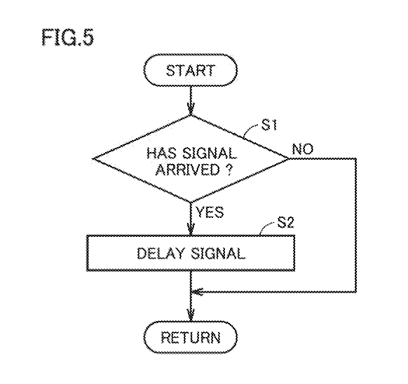

FIG. 4 is a sequence diagram illustrating discovery processing in an OLT when delay of transmission of an optical signal is set in an optical signal repeater. Referring to FIGS. 2 and ONU 74 is provided on a communication path shortest in transmission distance from OLT 2 among the branched communication paths. Delay element 72a delays transmission of the discovery gate from OLT 2 to ONU 74.

In one embodiment, a delay is set to substantially be as long as the time period required for the discovery gate to be transmitted over distance L2. Virtually, a distance from OLT 2 to ONU 74 is equal to (L1+L2). Thus, ONU 74 is virtually located at a position the same as the position of ONU 3a. Thus, a difference in time period for transmission of an optical signal among a plurality of ONUs connected through the branched communication paths can be decreased.

A width (bandwidth) of the discovery window corresponds to a difference between distance L2 and the distance (L2+L3), that is, a bandwidth corresponding to distance L3. As is clear based on comparison between FIGS. 3 and 4, according to the first embodiment, the width of a discovery window can be made smaller.

In order to make the width of the discovery window smaller, a transmission delay in delay element 72a should only be greater than 0. When the delay is longer than a time period required for an optical signal to be transmitted over the distance (L2+L3), however, ONU 74 is virtually located farther from OLT 2 than ONUs 3b and 3c. Consequently, the discovery window is greater in width than window W2. Therefore, the delay is longer than 0 and not longer than the time period required for an optical signal to he transmitted over the distance (L2+L3).

Preferably, as shown in FIG. 4, the delay is set such that the width of the discovery window corresponds to the width of window W2. Therefore, the delay is preferably not shorter than a time period required for an optical signal to be transmitted over distance L2 and not longer than a time period required for an optical signal to be transmitted over the distance (L2+L3). More preferably, the delay is equal to a time period required for an optical signal to be transmitted over distance L2.

When an ONU receives a discovery gate, the ONU transmits a register request after lapse of a random delay. Therefore, the upper limit and the lower limit of the range of the delay can be set in consideration of the range of the random delay.

In order to make the width of the discovery window smaller, delay element 72a may delay transmission of a signal from ONU 74. In this case as well, the delay can be set to he within the range above. When delay element 72a delays transmission of both of a signal from OUT 2 (optical module 71 and a signal from ONU 74, a transmission delay of each signal can be set such that a total of transmission delays of the signals is within the range described above.

FIG. 5 is a flowchart showing processing in the delay element in the optical signal repeater according to the first embodiment. The processing shown in FIG. 5 is performed repeatedly, for example, with a certain period. Referring to FIGS. 2 and 5, transmission control unit 72 determines whether or not a signal has arrived at delay element 72a (step S1). In the embodiment, transmission control unit 72 sets a transmission path for a signal between any of the plurality of optical modules 71 and ONU 74. When delay element 72a receives the signal through that path, transmission control unit 72 determines that the signal has arrived at delay element 72a. A signal for which determination should be made may he any of a signal from optical module 71, a signal from ONU 74, and both of the signals.

When the signal has arrived at delay element 72a (YES in step S1), delay element 72a delays transmission of the signal (step S2). When the signal has not arrived at delay element 72a (NO in step S1), processing in delay element 72a is not performed.

As set forth above, according to the first embodiment, optical signal repeater 7 has ONU 74 for monitoring. Delay element 72a delays transmission of a signal transmitted between ONU 74 and OLT 2. Thus, a difference in transmission time period due to a difference in transmission distance of an optical signal between the optical line terminal and the plurality of optical network units connected through the branched communication paths can be decreased. Therefore, since a bandwidth of a discovery window can be made smaller, for example, in the OLT, throughput can be improved.

<Second Embodiment>

An optical signal repeater not containing an ONU for monitoring can also be applied to an optical communication system, in such an optical communication system, a delay is determined based on lengths of communication paths for ONUs connected to the optical signal repeater through branched communication paths.

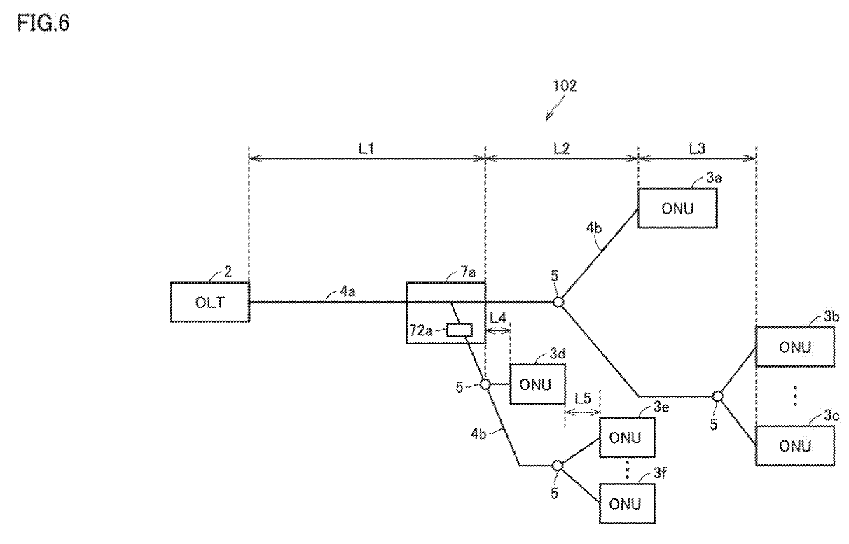

FIG. 6 is a schematic diagram showing a configuration example of an optical communication system 102 according to a second embodiment of the present invention. Referring to FIG. 6, optical communication system 102 is basically the same in configuration as optical communication system 101 shown in FIG. 1. Optical signal repeater 7 branches a communication path from OLT 2, for example, into two. For example, the optical signal repeater has two ports. ONUs 3a, 3b, and 3c are connected to a first port through branch optical fibers 4b and optical splitters 5. ONUs 3d, 3e, and 3f are connected to a second port through branch optical fibers 4b and optical splitters 5.

L4 represents a distance from optical signal repeater 7 to ONU 3d. L5 represents a distance from ONU 3d to ONUs 3e and 3f In the description below, it is assumed that relation of L4<L2 and L5≦5≦L3 is satisfied. Distances L1 , L2, and L3 shown in FIG. 6 are the same as distances L1, L2, and L3 in the first embodiment, respectively

Optical signal repeater 7 includes delay element 72a. Delay element 72a is provided on the shortest communication path among the branched communication paths. In the example shown in FIG. 6, delay element 72a is provided on a communication path between our 2 and ONU 3d and delays transmission of a signal through that communication path.

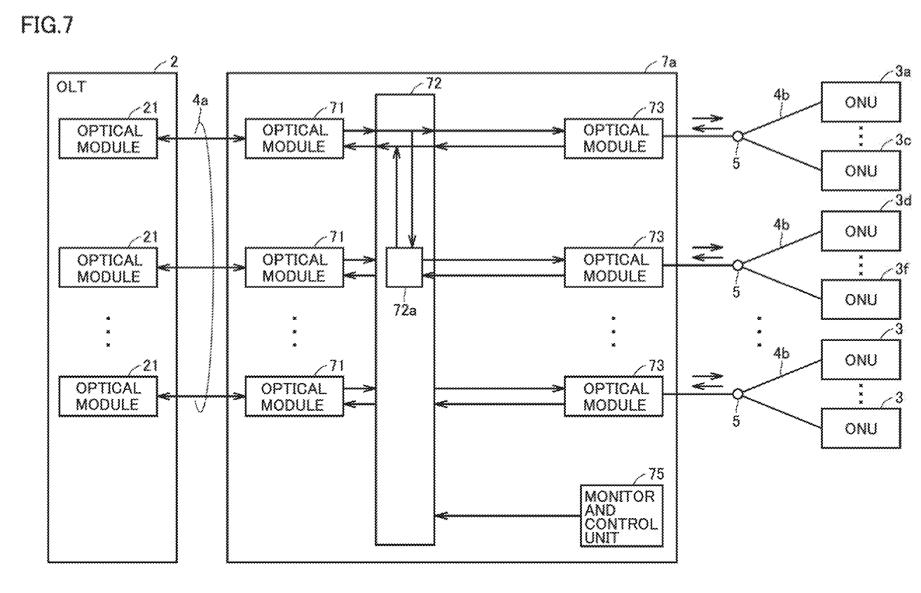

FIG. 7 is a block diagram showing one example of a configuration of the optical signal repeater according to the second embodiment. Referring to FIG. 7, according to the second embodiment, optical signal repeater 7 is different from the optical signal repeater shown in FIG. 2 in not including ONU 74. The optical signal repeater shown in FIG. 7 is otherwise the same in configuration as the corresponding portion shown in FIG. 2.

For example, transmission control unit 72 sets a communication path such that a signal from one optical module 71 is branched to two optical modules 73. A signal from each of these two optical modules 73 is transmitted to that optical module 71 under the control by transmission control unit 72. The configuration shown in FIG. 6 can thus be realized.

Delay element 72a delays transmission of a signal through a path on which each of ONUs 3d to 3f is connected, of the two communication paths. Since the processing in delay element 72a is the same as the processing shown in FIG. 5, description hereafter will not be repeated.

Referring again to FIG. 3, when delay element 72a does not delay transmission of a signal to ONU 3d to ONU 3f window W1 corresponding to a difference L2-L4) between distance L2 and distance L4 is required. In the second embodiment, delay element 72a delays transmission of a signal sent to the ONU (ONU 3d) closest to OLT 2 by a time period required for an optical signal to travel a distance (L2-L4). Thus, a transmission distance of a signal from OLT 2 to ONU 3d is virtually the same as a transmission distance of a signal from OLT 2 to ONU 3a, Therefore, according to the second embodiment, as shown in FIG. 4, a width of the discovery window can be made smaller.

The delay is preferably longer than 0 and not longer than a time period required for an optical signal to be transmitted over a distance {(L2+L3)-(L4+L5)}. More preferably, the delay is not shorter than a time period required for an optical signal to be transmitted over the distance (L2-L4) and not longer than a time period required for an optical signal to be transmitted over the distance {(L2+L3)-(L4+L5)}. Further preferably, the delay is equal to a time period required for an optical signal to be transmitted over the distance (L2-L4). In this case, the width of window W2 can be a width corresponding to distance L3.

When relation of L5>L3 is satisfied, the delay is preferably longer than 0 and not longer than a time period required for an optical signal to be transmitted over the distance (L2-L4). Preferably, the delay is not shorter than a time period required for an optical signal to be transmitted over the distance {(L2+L3)-(L4+L5)} and not longer than a time period required for an optical signal to be transmitted over the distance (L2-L4). Further preferably, the delay is equal to a time period required for an optical signal to he transmitted over the distance {(L2+L3)-(L4+L5)}. In this case, a width of window W2 can be a width corresponding to distance L5.

As set forth above, according to the second embodiment, as in the first embodiment, a difference in transmission time period due to a difference in transmission distance of an optical signal between the optical line terminal and the plurality of optical network units connected through the branched communication paths can be made smaller. As in the first embodiment, according to the second embodiment, since a bandwidth of the discovery window can be made smaller, for example, in the OLT, throughput can be improved.

In the second embodiment as in the first embodiment, delay element 72a may also delay transmission of a signal (a message) of a specific type. Alternatively, delay element 72a may delay transmission of a signal regardless of a type of a signal. Alternatively, delay element 72a may delay transmission of a signal sent from ONU 3d. Alternatively, delay element 72a may delay transmission of both of a signal sent from OLT 2 to ONU 3d and a signal sent from ONU 3d.

It should be understood that the embodiments disclosed herein are illustrative and non-restrictive in every respect The scope of the present invention is defined by the terms of the claims, rather than the embodiments above, and is intended to include any modifications within the scope. and meaning equivalent to the terms of the claims.

### REFERENCE SIGNS LIST

2 optical line terminal (OLT); 3, 3a, 3b, 3c, 74 optical network unit (ONU); 4a trunk optical fiber; 4b branch optical fiber; 5 optical splitter; 7 optical signal repeater; 21, 71, 73 optical module; 72 transmission control unit; 72a delay element; 75 monitor and control unit; 101, 102 optical communication system; L1 to L5 distance; S1, S2 step, and W1, W2 window.

1. An optical signal repeater configured to repeat an optical signal transmitted between an optical line terminal and a plurality of optical network units connected through branched communication paths, the optical signal repeater comprising:
a delay element provided between the optical network unit connected to the optical line terminal through a shortest communication path among the branched communication paths and the optical line terminal, and configured to delay transmission of an optical signal transmitted through the shortest communication path.

2. The optical signal repeater according to claim 1, wherein
the optical network unit connected through the shortest communication path among the plurality of optical network units is included in the optical signal repeater.

3. The optical signal repeater according to claim 1, wherein
the delay element delays transmission of the optical signal transmitted between the optical line terminal and the plurality of optical network units when the optical line terminal performs discovery processing.

4. An optical communication system comprising:
an optical line terminal;
branched communication paths;
a plurality of optical network units connected through the branched communication paths; and
an optical signal repeater configured to repeat an optical signal transmitted between the optical line terminal and each of the plurality of optical network units,
the optical signal repeater configured to delay transmission of the optical signal transmitted between the optical network unit connected to the optical line terminal through a shortest communication path among the branched communication paths and the optical line terminal.

5. A method of repeating an optical signal between an optical line terminal and a plurality of optical network units connected to the optical line terminal through branched communication paths, the method comprising the step of:
delaying transmission of the optical signal transmitted between the optical network unit connected to the optical line terminal through a shortest communication path among the branched communication paths and the optical line terminal.
